(19) United States
(12) Patent Application Publication
(10) Pub. No.: US 2018/0303278 A1
(43) Pub. Date: Oct. 25, 2018

(54) GLASS JUG

(71) Applicant: MELITTA EUROPA GMBH & CO. KG, Minden (DE)

(72) Inventor: Andreas SACHTLEBEN, Minden (DE)

(73) Assignee: MELITTA EUROPA GMBH & CO. KG, Minden (DE)

(21) Appl. No.: 15/960,494

(22) Filed: Apr. 23, 2018

(30) Foreign Application Priority Data
Apr. 25, 2017 (DE) 20 2017 102 438.5

(51) Int. Cl. A47J 31/44; A47G 19/14

(52) U.S. Cl. CPC A47J 31/4457; A47J 31/10; A47G 19/14

(57) ABSTRACT

A glass jug includes a glass body having a top side with an opening, a lid for covering the opening and a handle protruding from the glass body. The body includes level marks for indicating a quantity of liquid contained in the glass body, wherein the level marks comprise profiles integrally formed with the glass body.

### CROSS-REFERENCE TO RELATED APPLICATION

This application claims priority to German Application No. 20 2017 102 438.5, filed Apr. 25, 2017, the disclosure of which is incorporated by reference in its entirety.

### BACKGROUND OF THE INVENTION

The present invention relates to a glass jug, in particular for a coffee machine, comprising a glass body, a lid provided on an opening of the glass body and a handle protruding from the glass body whereby level marks are provided on the glass body for indicating the amount of liquid contained in the glass body.

European patent application EP 2 700 337 B1 describes a coffee machine in which a container in the form of a glass jug is provided under a filter holder and which collects brewed coffee flowing from the filter holder. Such glass jugs have proven their worth, particularly for coffee machines, where they are used on the one hand to receive the prepared coffee and on the other hand to fill a water tank in the coffee machine. The glass jug is held under a tap and filled with water in order to prepare the desired amount of coffee. Here, it is helpful if the glass jug has level marks, which are usually printed on the glass body or on a handle fitted to the glass jug. However, the printing of level marks requires an additional manufacturing step. Also, the accuracy of the marks is limited because the glass jug may be kept slightly tilted during the filling process.

### SUMMARY OF THE INVENTION

An object of the present invention is to provide a glass jug, which is easy to produce and ensures optimized handling during filling.

The above and other objects are achieved by the provision of a glass jug, which in one embodiment comprises: a glass body having a top side with an opening; a lid for covering the opening; and a handle protruding from the glass body, wherein the body includes level marks for indicating a quantity of liquid contained in the glass body, and wherein the level marks comprise profiles integrally formed with the glass body. This eliminates the additional step of having to print level marks, as these are provided by profiles integral with the glass body. The level marks are thus clearly visible and improve handling when filling the glass jug.

In another embodiment the level marks are arranged to completely encircle the glass body on different horizontal planes. The level marks may, optionally, also be semi-circular, but should extend around at least 30% of the circumference, preferably more than 60%. Level marks that completely encircle the glass vessel have the advantage that it is easy to see if the bottom of the glass jug is in a horizontal position during the filling process, because if the glass jug is in an inclined position, the surface of the liquid will be at an angle to the horizontally arranged level marks.

In another embodiment the glass jug is provided with at least three level marks, preferably four to eight level marks. That way, each level mark can correspond to one or two full cups, so that the user can easily fill the glass jug with the quantity required for preparing the coffee.

So as to achieve a visually appealing appearance, the glass body is designed to be rotationally symmetrical except for a pouring point at the opening. A protruding spout can be provided at the pouring point to facilitate pouring. Incidentally, if the design of the glass body is rotationally symmetrical, the volume of the glass body can be optimally used in a coffee machine; this design also improves the cleaning of the glass body.

A simple attachment of the handle to the glass body can be achieved through the use of a clamping band, which is set into a recess in the glass body.

The profiles formed integrally with the glass body may be formed as outwardly projecting ridges or as recessed grooves on the outside of the glass body. The grooves or ridges should have a width of 0.5 to 3 mm, preferably 1 mm to 2 mm, in order to be both easily visible and easy to clean. Optionally, in addition to the level marks, markings in the form of numbers or symbols can be provided on the handle or the glass body for indicating the filling quantity of the glass jug.

### BRIEF DESCRIPTION OF THE DRAWINGS

The invention will be explained in more detail below on the basis of an embodiment, which is illustrated in the attached drawings, in which show:

FIG. 1 is a side view of a glass jug according to the invention;

FIG. 2 is a sectional detail view of one embodiment of the glass jug shown in FIG. 1;

FIG. 3 is a sectional detail view of another embodiment of the glass jug shown in FIG. 1; and

FIG. 4 is a side view of another embodiment of the invention.

### DETAILED DESCRIPTION OF THE INVENTION

A glass jug 1 comprises a glass body 2 with an opening 3 provided on its upper side. The opening 3 is at least partially covered by a lid 4, which is detachably held at the opening, preferably by a hinged connection, so that it can be pivoted by pressing on an actuating element. A pouring point 5 or a spout is provided on one side of the opening 3, which allows liquid to be poured even when the lid 4 is closed. With the exception of the pouring point 5, the glass body 2 is rotationally symmetrical.

In addition, a protruding handle 6 is attached to the glass body 2, which is held, on the one hand, on the upper side of the glass body 2 and, on the other, fixed in position by a clamping band 7, which is arranged circumferentially above the horizontal bottom 8 of the glass body 2. The term “horizontal” refers to the standing position of the glass jug 1 when it is placed on a flat horizontal surface.

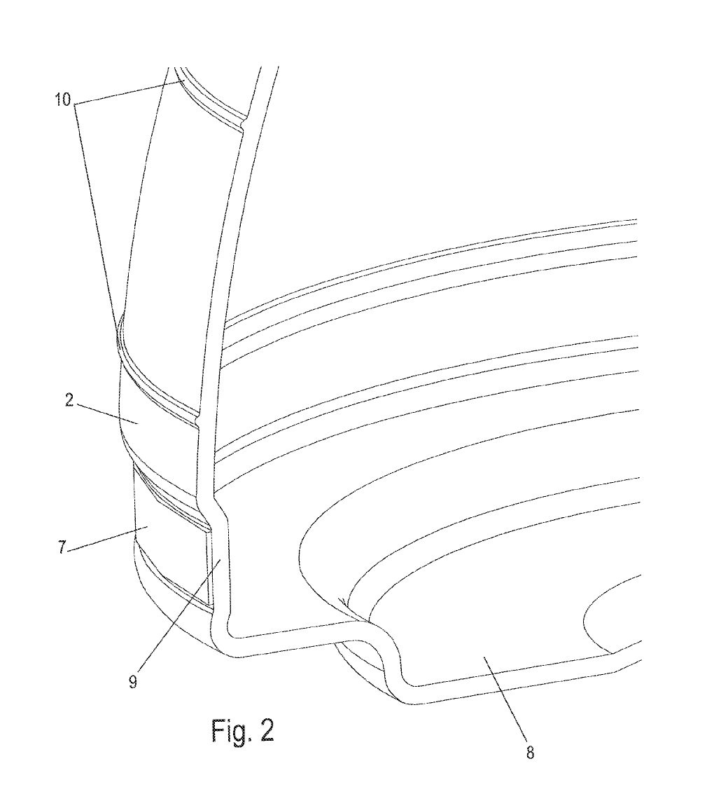

As shown in FIG. 2, the bottom 8 has a step-like shape that ends in a wall, on which, adjacent to the bottom 8, there is an annular recess 9, in which the circumferential clamping band 7 is seated. Above the clamping band 7, circular profiles in the form of ridges 10 are provided on the side wall of the glass body 2, which protrude from the outside of the glass body 2, by, for example, 0.2 mm to 3 mm, but ideally by 0.5 mm to 2 mm. The width of the ridges 10 can also range between 0.2 mm and 3 mm, but ideally between 0.5 mm and 2 mm. In any case, the ridges 10 are visible from the outside and serve as level marks to indicate to the user when filling the glass jug 1, the amount of liquid poured into it. Due to the annular course of the ridges 10, the user can also see if the bottom 8 is aligned parallel to the horizontal plane, which makes a comparatively accurate filling of the glass jug 1 possible.

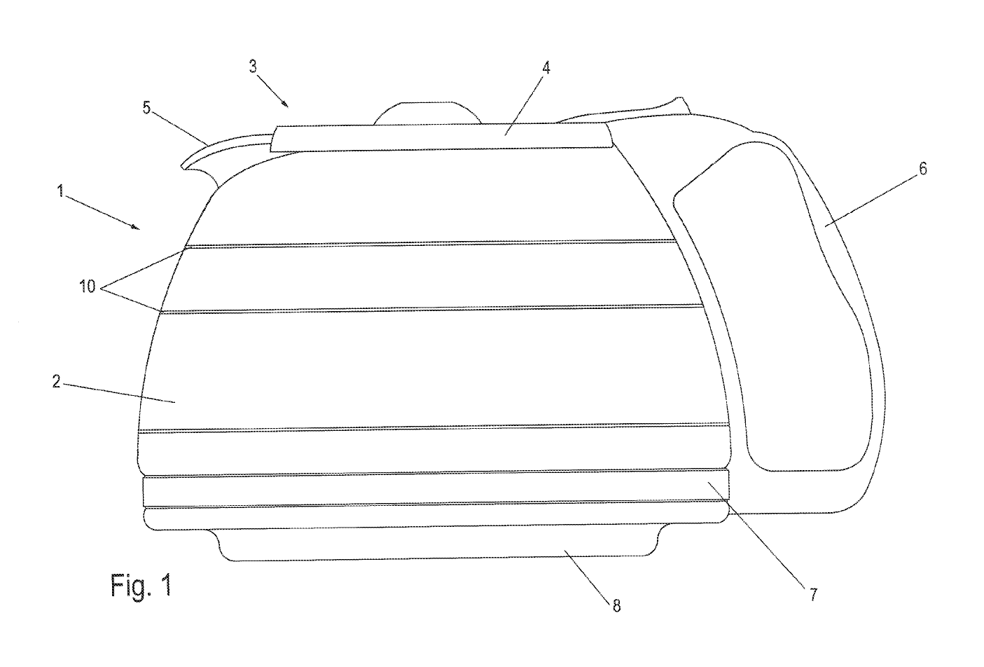

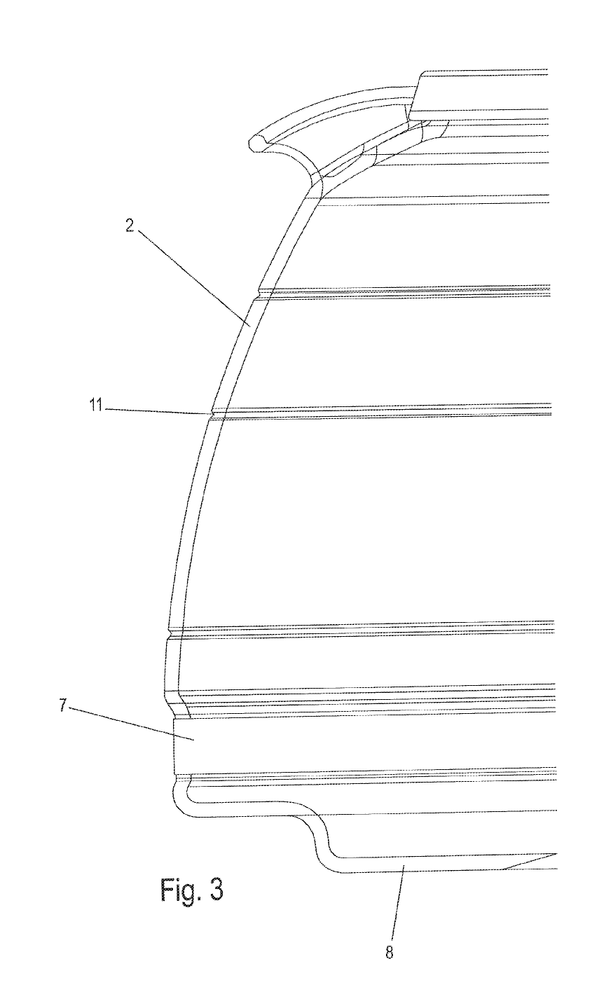

FIG. 3 shows a modified form of a glass jug, which is formed as in FIG. 1, except that instead of the outwardly protruding ridges 10, grooves 11 are provided on the outer wall of the glass body 2 to serve as level marks. The grooves 11 can have a width and/or depth between 0.2 mm and 3 mm, but ideally between 0.5 mm and 2 mm, to form a visible indicator for the user when pouring a liquid into the glass jug 1.

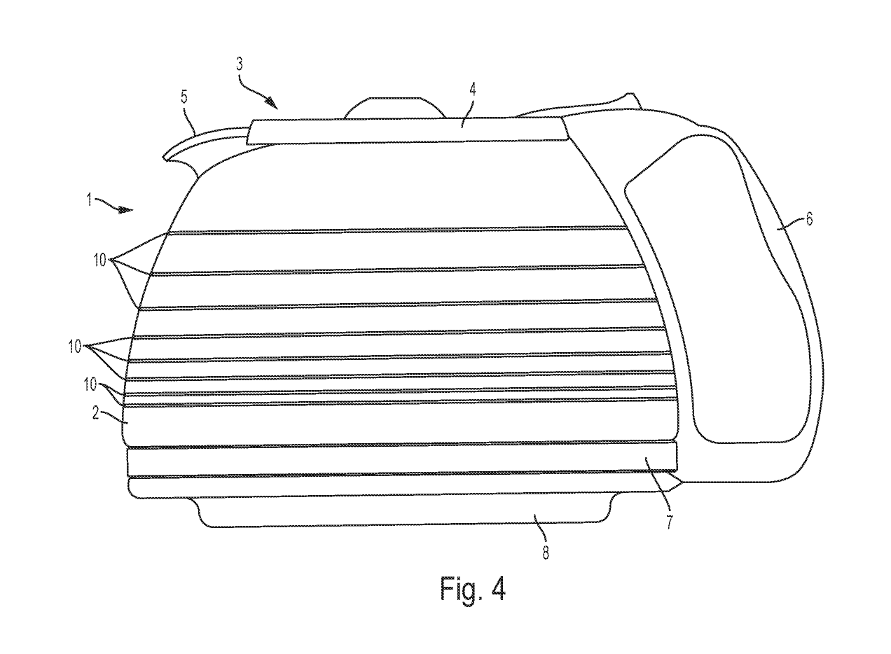

Depending on the size of the glass jug 1, the level marks in the form of ridges 10 or grooves 11 can be used to indicate a filling quantity corresponding to one or two cups, so that three to ten level marks can be provided, distributed over the height of the glass body 2. FIG. 4 shows and exemplary embodiment similar to the embodiment of FIG. 1, but with eight level marks 10.

In the illustrated design example, the ridges 10 and grooves 11 are formed to encircle the glass body 2. It is also possible to extend the level marks only over a part of the circumference of the glass body 2, for example over half the circumference, or to an extent corresponding to only 20% of the circumference or more. The geometry of the level marks can also be modified.

As an option, it is also possible to provide not only the level marks, but also symbols or markings which indicate to the user the number of cups that correspond to the level mark.

It will be understood that the above description of the present invention is susceptible to various modifications, changes and adaptations, and that the same are intended to be comprehended within the meaning and range of equivalents of the appended claims.

What is claimed is:

1. A glass jug, comprising:
a glass body having a top side with an opening;
a lid for covering the opening; and
a handle protruding from the glass body;
wherein the body includes level marks for indicating a quantity of liquid contained in the glass body, and wherein the level marks comprise profiles integrally formed with the glass body.

2. The glass jug according to claim 1, wherein the level marks extend around the circumference of the glass body in different horizontal planes.

3. The glass jug according to claim 1, wherein the level marks include at least three level marks.

4. The glass jug according to claim 1, wherein the glass body is rotationally symmetrical except for a pouring point at an edge of the opening.

5. The glass jug according to claim 1, wherein the glass body includes a circumferential recess; and further including a band clamped to the glass body in the circumferential recess, and wherein the handle is fixed to the glass body by the clamping band.

6. The glass jug according to claim 1, wherein the profiles comprise outwardly projecting ridges on the glass body.

7. The glass jug according to claim 1, wherein the profiles comprise groove-shaped recesses on the outside of the glass body.

8. The glass jug according to claim 1, further including number or symbol level marks on the glass jug to indicate the filled quantity.

9. The glass jug according to claim 1, wherein the level marks include four to eight level marks.

10. A method of filling a coffee machine with water, comprising utilizing the glass jug according to claim 1.
